(19) United States
(12) Patent Application Publication
(10) Pub. No.: US 2015/0281608 A1
(43) Pub. Date: Oct. 1, 2015

(54) IMAGING ELEMENT AND IMAGING APPARATUS

(71) Applicant: Panasonic Intellectual Property Management Co., Ltd., Osaka (JP)

(72) Inventor: Hiroyuki MIYAHARA, Osaka (JP)

(21) Appl. No.: 14/517,984

(22) Filed: Oct. 20, 2014

(30) Foreign Application Priority Data
Mar. 28, 2014 (JP) 2014-068173
Aug. 4, 2014 (JP) 2014-158313

(51) Int. Cl. H04N 5/365; H04N 5/232; H04N 9/04; G06T 3/40

(52) U.S. Cl. CPC H04N 5/3651; G06T 3/4015; H04N 5/23245; H04N 9/045

(57) ABSTRACT

An imaging element includes a plurality of types of smaller array units, each of which is configured with a plurality of types of color filters arranged in three rows by three columns. The color filters includes a first color filter and a second color filter which has a spectral characteristic different from that of the first color filter. These smaller array units are arranged in two rows by two columns to configure a larger array unit. Then, the smaller array units are disposed such that a first centroid position coincides with a second centroid position, in the larger array unit. The first centroid is formed with pixels used in pixel addition processing for pixel information based on light transmitted through the first color filters. The second centroid is formed with pixels used in pixel addition processing for pixel information based on light transmitted through the second color filters.

### BACKGROUND

1. Technical Field

The present disclosure relates to an imaging element having a plurality of types of color filters, and imaging apparatus equipped with the imaging element.

2. Background Art

A conventional imaging element includes a pixel array part and a color filter part. The pixel array part is such that pixels are arranged two-dimensionally in a matrix. The color filter part is such that colors of principal components of a luminance signal are arranged checkerwise at portions in the color filter part, and that a plurality of colors of color information components is arranged at the remaining portions. Each of the pixels of the pixel array part outputs a signal corresponding to the color array of the color filter part. The imaging element converts the signal into a signal corresponding to a Bayer array, and then outputs the converted signal.

### SUMMARY

An imaging element according to the present disclosure includes a plurality of types of smaller array units, and larger array units that are each configured with the plurality of types of the smaller array units disposed in two rows by two columns. Each of the smaller array units is configured with a plurality of color filters disposed in three rows by three columns. Each of these color filters includes a first color filter and a second color filter having a spectral characteristic different from that of the first color filter. Pixels used in pixel addition processing for pixel information based on light transmitted through the first color filters, have a first centroid position in the larger array unit. On the other hand, pixels used in pixel addition processing for pixel information based on light transmitted through the second color filters, have a second centroid position in the larger array unit. The plurality of types of the smaller array units is disposed such that the first centroid position coincides with the second centroid position.

In accordance with the present disclosure, it is possible to provide an imaging element capable of generating still images and moving images with preventing false signals from occurring, and to provide the imaging apparatus equipped with the imaging element.

### BRIEF DESCRIPTION OF DRAWINGS

FIG. 1 is a block diagram illustrating a configuration of a video camcorder according to a first embodiment.

FIG. 2 is a view illustrating centroid positions of added pixels for a Bayer array, i.e. a commonly used array.

FIG. 3 is a graph illustrating spectral sensitivity characteristics of color filters (R, G, B, W, and Mg).

FIG. 4 is a view of an example of smaller array units of a CMOS image sensor, where each of the smaller array units are configured with a plurality of pixels arranged in three rows by three columns.

FIG. 5 is a view illustrating a pixel addition operation.

FIG. 6 is a view illustrating centroid positions of added pixels for an example of a larger array unit which is configured with a plurality of types of the smaller array units arranged in two rows by two columns.

FIG. 7 is a flow chart of the pixel addition operation.

FIG. 8 is a first view for illustrating the pixel addition operation.

FIG. 9 is a second view for illustrating the pixel addition operation.

FIG. 10 is a third view for illustrating the pixel addition operation.

FIG. 11 is a view of other examples of the smaller array units of the CMOS image sensor.

FIG. 12 is a view illustrating centroid positions of added pixels for an example of a larger array unit which is configured with the smaller array units shown in FIG. 11.

FIG. 13 is a view illustrating centroid positions of added pixels for still another example of the larger array unit.

FIG. 14 is a view illustrating a centroid position of added pixels for yet another example of the larger array unit.

### DETAILED DESCRIPTION OF PREFERRED EMBODIMENTS

Prior to descriptions of embodiments according to the present disclosure, problems of conventional imaging elements will be described.

In recent years, a digital still camera (abbreviated as DSC, hereinafter) and a video camcorder have become widespread which are capable of generating high definition images, i.e. moving images as well as still images, through the use of a high-resolution imaging element. The image size of an imaging element is determined in accordance with specifications of the DSC or the video camcorder. An increase in the number of pixels leads to miniaturization of their pixel size, resulting in a reduced sensitivity and a deteriorated S/N ratio. For this reason, the increase in the number of the pixels has been a problem in view of image quality. Moreover, since the increase in the number of the pixels is aimed at increasing resolution, occurrence of false signals also becomes a factor in impairing the image quality.

In these years, a function of generating moving images has come to be commonly used. According to the function, the number of signals to be processed is reduced by adding pixel signals within an imaging sensor. On the other hand, however, because the modulation components of signals based on homochromatic pixels (R, Gr and Gb, B) are in the same phase, the addition of the pixel signals within the imaging sensor can cause false signals of colors, resulting in a degraded image quality.

The present disclosure is intended to provide an imaging element capable of generating still images and/or moving images with false signals being suppressed, and to provide imaging apparatus equipped with the imaging element.

### FIRST EXEMPLARY EMBODIMENT

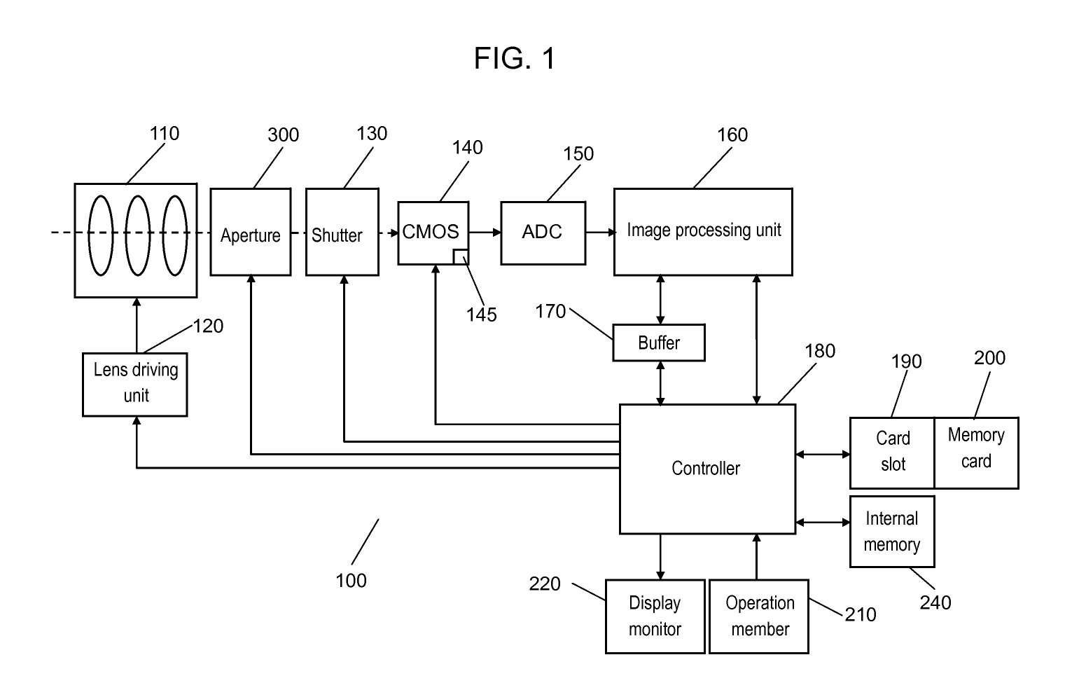

Hereinafter, a first exemplary embodiment will be described with reference to the accompanying drawings. FIG. 1 is a block diagram illustrating a configuration of video camcorder 100 according to the first exemplary embodiment. First, as an example of the embodiment, descriptions will be made regarding the configuration and operation of video camcorder 100, and regarding a filter array of CMOS image sensor (referred to as sensor, hereinafter) 140.

(1-1. Outline)

Video camcorder 100 is capable of generating still images and moving images by using sensor 140, i.e. the same imaging element. Color filters of sensor 140 are arranged in three rows by three columns to form a plurality of types of smaller array units. Then, the plurality of types of the smaller array units are arranged in two rows by two columns to form a larger array unit.

In the configuration, pixels used in pixel addition processing for pixel information based on light transmitted through first color filters included in the plurality of the color filters, have a first centroid position in the larger array unit. On the other hand, pixels used in pixel addition processing for pixel information based on light transmitted through second color filters included in the plurality of the color filters, have a second centroid position in the larger array unit. The plurality of types of the smaller array units are disposed such that the first centroid position coincides with the second centroid position. This configuration makes it possible to generate still images and moving images, with preventing false signals from occurring.

Moreover, each of the plurality of types of the smaller array units includes a plurality of third color filters arranged checkerwise. Each of the third color filters has spectral characteristics different from those of the first color filters and the second color filters. Pixels used in pixel addition processing for pixel information based on light transmitted through the plurality of the third color filters, have a third centroid position in the larger array unit. The plurality of types of the smaller array units is arranged such that the third centroid position coincides with the above-described first and second centroid positions. With this configuration, video camcorder 100 is capable of outputting image information with higher image quality and efficiency through the use of sensor 140 when generating moving images as well as still images.

Hereinafter, descriptions will be made regarding the configurations and operations of video camcorder 100 and the filter array of sensor 140, with reference to the drawings. Note that, in the following descriptions, an R-color filter (R-filter, hereinafter) refers to the first color filter, a B-color filter (B-filter, hereinafter) refers to the second color filter, and a G-color filter (G-filter, hereinafter) refers to the third color filter. The R-filter, B-filter, and G-filter are color filters that selectively transmit red color, blue color, and green color, respectively. Moreover, in the following descriptions, either a W-color filter containing light transmission components of R, G, and B, or a Mg-color filter (a magenta filter) refers to a fourth color filter. Furthermore, in the following descriptions, the W-color filter and the Mg-color filter are shortly referred to as the W-filter and the Mg-filter, respectively.

When the W-filter is used, the fourth color filter has spectral transmittance higher than that of any of the R-filter, B-filter, and G-filter, i.e. the first to third color filters. When the Mg-filter is used, the fourth color filter has spectral transmittance higher than that of any of the R-filter and B-filter. That is, the fourth color filter has the spectral transmittance higher than that of any of the first color filter and the second color filter. It is noted, however, the first to fourth color filters are not limited to the configuration described above.

(1-2. Configuration of Video Camcorder 100)

An electrical configuration of video camcorder 100 will be described with reference to FIG. 1. Video camcorder 100 includes optical system 110, aperture 300, shutter 130, sensor 140, analog/digital converter (referred to as

ADC, hereinafter) 150, image processing unit 160, buffer 170, and controller 180. Video camcorder 100 further includes card slot 190 capable of accommodating memory card 200, lens driving unit 120, internal memory 240, operation member 210, and display monitor 220.

In video camcorder 100, sensor 140 generates a subject image formed by optical system 110 configured with one or more lenses. Image data generated by sensor 140 are subjected to various processes in image processing unit 160, and then stored in memory card 200.

Sensor 140 picks up the subject image formed by optical system 110 to generate the image data. Sensor 140 performs various operations including an exposure, transfer, and electronic shutter operations. Sensor 140 includes a plurality of pixels and photodiodes (not shown) which are disposed corresponding to the respective pixels. That is, on a light receiving face of sensor 140, a large number of the photodiodes are arrayed two-dimensionally.

Moreover, sensor 140 includes various types of color filters that are disposed in a predetermined array corresponding to the respective pixels. In the present embodiment, there are employed four types of the color filters, i.e. the R-, G-, B-, and W-filters. Note that, instead of the W-filters, Mg-filters may be employed. For each of the pixels, any one of the four types of the color filters is disposed. Hereinafter, the pixel in which the R-filter, G-filter, B-filter, or W-filter is disposed is referred to as “pixel-R,” “pixel-G,” “pixel-B,” or “pixel-W,” respectively.

Each of the pixels receives light transmitted through the corresponding color filter, and outputs a signal (pixel information) in accordance with intensity of the received light. The array of the color filters of sensor 140 will be described in detail later.

Moreover, sensor 140 incorporates adder 145 therein. Adder 145 performs “pixel addition,” and outputs the resulting signal. The “pixel addition” is a processing in which signals output from a plurality of the pixels of sensor 140 are added to generate one signal (image information). The pixel addition will also be described in detail later.

ADC 150 converts the analog image data generated by sensor 140 into digital image data.

Image processing unit 160 applies various processes to the image data generated by sensor 140, thereby generating an image data to be displayed on display monitor 220, and generating an image data to be stored in memory card 200. For example, image processing unit 160 applies various processes, including a gamma correction, a white balance correction, and a flaw correction, to the image data generated by sensor 140. Moreover, image processing unit 160 compresses the image data generated by sensor 140 into a compression format in conformity with H.264 standard, MPEG2 standard, or the like. Image processing unit 160 can be formed of a digital signal processor (DSP), a microprocessor, and the like.

Controller 180 controls the whole of video camcorder 100. Controller 180 can be formed with semiconductor elements and the like. Controller 180 may be configured with either hardware only or a combination of hardware and software. Controller 180 can be formed of a microprocessor and the like.

Buffer 170 functions as a work memory of image processing unit 160 and controller 180. Buffer 170 can be formed of a dynamic random access memory (DRAM) or a ferroelectric memory, for example.

Card slot 190 is capable of accommodating memory card 200. Card slot 190 is capable of being coupled mechanically and electrically with memory card 200. Memory card 200 incorporates a flash memory, a ferroelectric memory, or the like therein, and is capable of storing data including an image file generated by image processing unit 160.

Internal memory 240 includes a flash memory, a ferroelectric memory, or the like. Internal memory 240 stores a control programs and the like to control the whole of video camcorder 100.

Operation member 210 includes a user interface which accepts operations from a user. Operation member 210 includes, for example, a cross key, a decision button, an operation button to switch various operation modes, an instruction button for generating still images, and an instruction button for generating moving images. They are capable of accepting the operations by the user.

Display monitor 220 is capable of displaying images (through-images) indicated by the image data generated by sensor 140, and images indicated by image data read from memory card 200. In addition, display monitor 220 is also capable of displaying various modes of menu screens useful in performing various kinds of setting of video camcorder 100.

(1-3. Color Filter Array of Sensor 140)

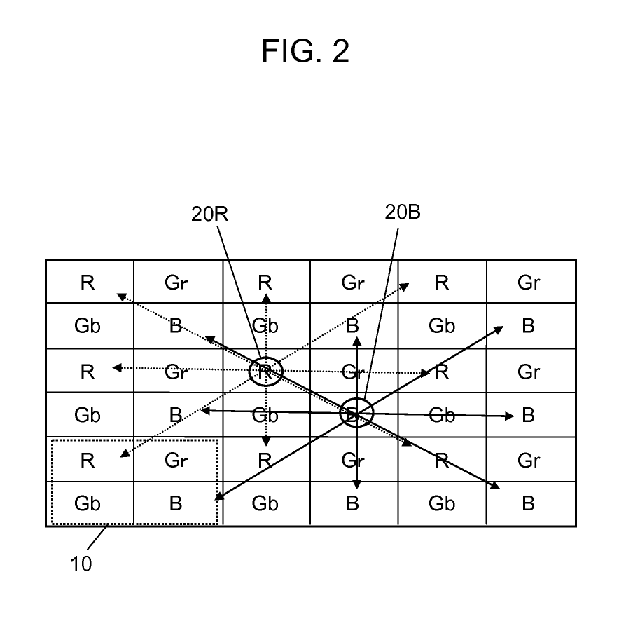

FIG. 2 is a view illustrating a Bayer array, i.e. a pixel array commonly-used. As shown in FIG. 2, in the Bayer array, Bayer basic array 10 is repeatedly arrayed which is configured with three types of the color filters, i.e. the R-filters, G-filters, and B-filters. In the Bayer array, the G-filters are arranged checkerwise. The R-filters and B-filters are arranged such that each of them is located adjacent only to the G-filters. Note that, in FIG. 2, the G-filters present in a row involving the R-filters are indicated as “Gr,” while the G-filters present in a row involving the B-filters are indicated as “Gb.”

FIG. 2 shows centroid positions 20R and 20B of pixels, in the Bayer array, which are used for the addition of image information based on lights transmitted through the R-filters and B-filters, respectively. As shown in the Figure, centroid position 20R does not coincide with centroid position 20B. Moreover, when viewed among either R-pixels only or B-pixels only, modulation components of either R or B to be added are in phase with each other, resulting in no reduction in moiré components of either R-color or B-color, respectively. That is, false signals occur outstandingly.

Hence, hereinafter, a color filter array according to the embodiment will be described which suppresses the occurrence of the false signals. Furthermore, a color filter array capable of keeping higher resolution will also be described. Hereinafter, the array of the color filters included in sensor 140 is described in detail.

Sensor 140 includes four types of the color filters, i.e. the R-filters, G-filters, B-filters, and W-filters.

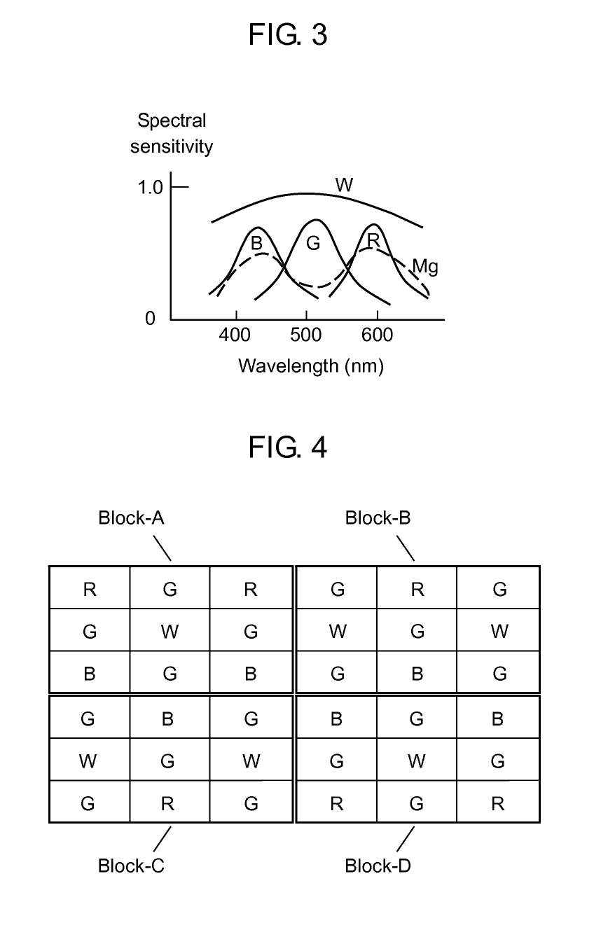

FIG. 3 is a graph illustrating wavelength characteristics of spectral sensitivity of the respective color filters. The R-filter has the characteristics of transmitting light of red color (R). The G-filter has the characteristics of transmitting light of green color (G). The B-filter has the characteristics of transmitting light of blue color (B). Then, the W-filter has an optical transmittance higher than that of the G-filter having the highest optical transmittance among those of the R-filter, G-filter, and B-filter, and has characteristics of transmitting light having the entire range of wavelengths concerned. For this reason, utilizing the W-filters is effective in increasing the sensor sensitivity. This allows the sensor to effectively form signals even under low light conditions.

Note that, instead of the W-filters, Mg-filters may be employed. The Mg-filters have a sensitivity to R- and B-colors. For this reason, utilizing the Mg-filters is effective in increasing the S/N ratio of color. So, although the Mg-filters may be substituted and arranged in the positions for the W-filters, the following descriptions are made regarding the array employing the W-filters.

The color filter array of sensor 140 is described which employs the four types of the color filters, i.e. the R-, G-, B-, and W-filters, selected from among the filters described above. Hereinafter, the color filter array is also referred to as the pixel array.

FIG. 4 is a view of the smaller array units (Block-A to Block-D) in sensor 140 according to the present embodiment. Each of the smaller array units is an array unit serving as a basic unit of three horizontal pixels by three vertical pixels, in the pixel array according to the embodiment. Each of the smaller array units of the pixels of sensor 140 is formed of the four types of the color filters including the R-filter, G-filter, B-filter, and W-filter.

In sensor 140, the G-filters are arranged checkerwise which have a high contribution rate to a luminance signal (referred as a Y⁻signal, hereinafter). The checkered-pattern arrangement of the G-filters makes it possible to ensure high resolution in luminance, resulting in a cancellation of moiré.

A description is now made regarding the array of three horizontal pixels by three vertical pixels (the array of three rows by three columns) in the smaller array unit. As described above, in each of Block-A to Block-D serving as the smaller array units, G-filters are arranged checkerwise in view of resolution in luminance. The W-filter corresponding to pixel-W having the highest sensitivity is disposed in the vertical centroid position of each of Block-A and Block-D. Moreover, in the larger array unit configured with Block-A to Block-D, the W-filters are disposed in horizontally alternating positions. With this configuration, it is possible to suppress the occurrence of false signals when interpolation of pixels-W is performed. Furthermore, the

W-filters are symmetrically disposed with respect to the filter at the center of the array of three rows by three columns in each of the smaller array units.

In the same way, the R- and B-filters are also arranged in consideration of the suppression of false signals. That is, the R-filters and B-filters are preferably arranged at mutually point-symmetric positions about the color filter at the center of the array of three rows by three columns in each of the smaller array units. In each of Block-A and Block-D, the R-filters and the B-filters are arranged mutually point-symmetrically about the W-filter at the center. In each of Block-B and Block-C, the R-filter and B-filter are arranged mutually point-symmetrically about the G-filter at the center.

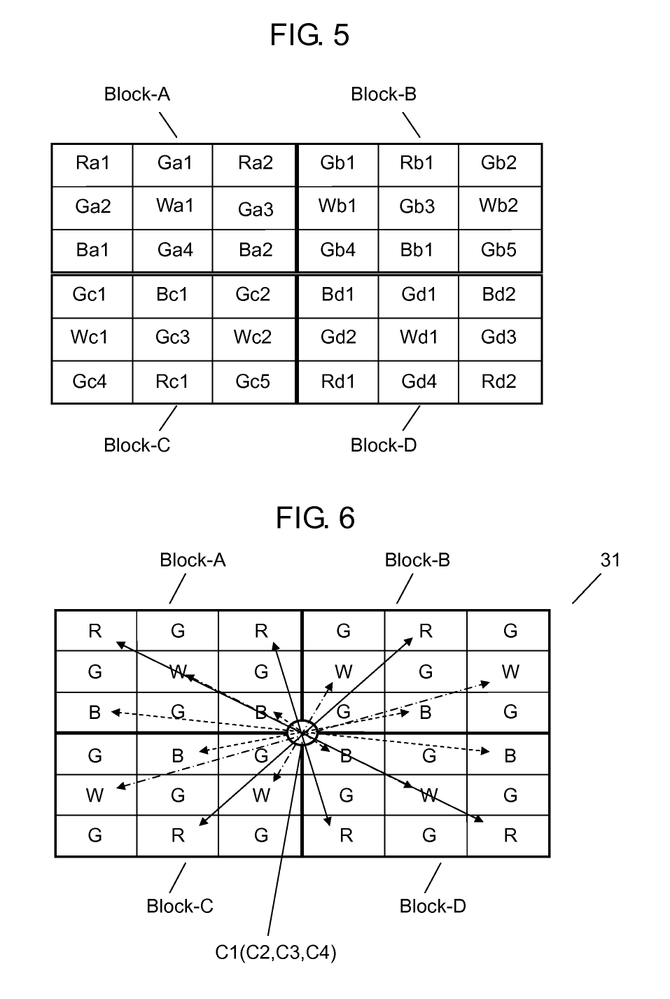

FIG. 5 is a view illustrating a pixel addition operation according to the present embodiment. Note that pixels-R, -G, -B, and -W of Block-A are indicated as Ra, Ga, Ba, and Wa, respectively. Similarly, pixels-R, -G, -B, and -W of Block-B are indicated as Rb, Gb, Bb, and Wb, respectively. In Block-C and Block-D, the similar indication are made.

Adder 145 of sensor 140 generates added signals using the output signals from the pixels. That is, adder 145 adds signals-R, signals-G, signals-B, and signal-W output from pixels-R, pixels-G, pixels-B, and pixel-W, by using following Eqs. (1) to (4) and (6) to (9), to generate added signal-R′, added signal-G′, added signal-B′, and added signal-W′, respectively. For example, in Block-A, adder 145 determines added signal-Ra′, added signal-Ga′, added signal-Ba′, and added signal-Wa′ by using Eqs. (1) to (4).

Ra′=(Ra1+Ra2)/2 (1)

Ga′=(Ga1+Ga2+Ga3+Ga4)/4 (2)

Ba′=(Ba1+Ba2)/2 (3)

Wa′=Wa (4)

Because signal-Wa includes color components of signal-Ra, signal-Ga, and signal-Ba, luminance signal-Ya of Block-A can be determined by using following Eq. (5). When luminance signal-Ya is configured using the signals obtained from the pixels in Block-A, luminance signal-Ya is obtained using Eq. (5) by substituting R-signal and B-signal which have a component in horizontally and vertically opposite phase with respect to pixel-W at the center of the block, respectively.

Ya=1/2×Ra′+3/2×Ga′+1/2×Ba′+1/2×Wa′ (5)

Block-D has the same array as that of Block-A except for that the R-filters and B-filters are disposed to change their places. Therefore, for the case of Block-D, the above Equations are required only to replace indexes “a” by indexes “d,” so that added signals-Rd′, -Gd′, -Bd′, and -Wd′ can be determined in the same manner as Eqs. (1) to (4), and that luminance signal-Yd can be determined in the same manner as Eq. (5).

In signal-Wa, its horizontal and vertical modulation components are in opposite phase with those of signals-Ra and signals-Ba. Accordingly, this allows signal-Wa to cancel the modulation components of signal-Ra and signal-Ba by using Eq. (5). Note that, the modulation component of signal-Gal is in opposite phase with that of signal-Ga4. Likewise, the modulation component of signal-Ga2 is in opposite phase with that of signal-Ga3. Therefore, computation of Eq. (2) causes false signal components of signal-Ga to cancel each other. This is also the case for Block-D.

Likewise, in Block-B, the R-filter and B-filter, as well as W-filters, are arranged point-symmetrically about the G-filter at the center of the array of three rows by three columns. Adder 145 of sensor 140 generates added signals using the output signals from the respective pixels. That is, adder 145 adds signal-R, signals-G, signal-B, and signals-W output from pixel-R, pixels-G, pixel-B, and pixels-W, by using following Eqs. (6) to (9), to generate added signal-Rb′, added signal-Gb′, added signal-Bb′, and added signal-Wb′, respectively. That is, in Block-B, adder 145 determines added signal-Ra′ to added signal-Wa′ by using Eqs. (6) to (9).

Rb′=Rb (6)

Gb′=(Gb1+Gb2+Gb4+Gb5)/4+2×Gb3 (7)

Bb′=Bb (8)

Wb′=(Wb1+Wb2)/2 (9)

Because signal-Wb includes the color components of signal-Rb, signal-Gb, and signal-Bb, luminance signal-Yb of Block-B can be determined by using following Eq. (10). When luminance signal-Yb is configured using the signals obtained from the pixels in Block-B, luminance signal-Yb is obtained using Eq. (10) by substituting signal-R and signal-B which have a component in horizontally and vertically opposite phase with respect to pixel-W at the center of the block, respectively.

Yb=1/2×Rb′+2/3×Gb′+1/2×Bb′+1/2×Wb′ (10)

Block-C has the same array as that of Block-B except for that the R-filter and B-filter are disposed to change their places. Therefore, for the case of Block-C, the above Equations are required only to replace indexes “b” by indexes “c,” so that added signals-Rc′, -Gc′, -Bc′, and -Wc′ can be determined in the same manner as Eqs. (6) to (9), and that luminance signal-Yc can be determined in the same manner as Eq. (10).

In signal-Wb, its horizontal and vertical modulation components are in opposite phase with those of signal-Rb and signal-Bb. Accordingly, this allows signal⁻Wb to cancel modulation components of signal-Rb and signal-Bb by using Eq. (10). Note that, the modulation components of signal-Gb1, signal-Gb2, signal-Gb4, and signal-Gb5 are in opposite phase with that of signal-Gb3. Therefore, computation of Eq. (7) causes false signal components of signal-Gb to cancel each other. This is also the case for Block-C.

FIG. 6 is a view illustrating centroid positions of added pixels for larger array unit 31 which is configured with the smaller array units arranged in two rows by two columns. In sensor 140, Block-A to Block-D are arranged in two rows by two columns, as shown in FIG. 6. Position C1 indicates the position of the centroid of the pixels that are used in the pixel addition processing for the pixel information based on the light transmitted through the R-filters, in larger array unit 31. Position C2 indicates the position of the centroid of the pixels that are used in the pixel addition processing for the pixel information based on the light transmitted through the B-filters, in larger array unit 31. Here, Block-A to Block-D are arranged such that position C1 coincides with position C2.

Moreover, position C3 indicates the position of the centroid of the pixels that are used in the pixel addition processing for the pixel information based on the light transmitted through the G-filters, in larger array unit 31. Here, Block-A to Block-D are preferably arranged such that position C3 coincides with positions C1 and C2.

Furthermore, position C4 indicates the position of the centroid of the pixels that are used in the pixel addition processing for the pixel information based on the light transmitted through the W-filters, in larger array unit 31. Block-A to Block-D are further preferably arranged such that position C4 coincides with positions C1 to C3.

FIG. 6 shows the centroid position (position C1) of pixels-R for the case where the additive synthesis is performed for horizontal six pixels by vertical six pixels. Position C1 indicated by the circle mark is the centroid of pixels-R. Likewise, pixels-B, pixels-G, and pixels-W are also arranged point-symmetrically in the larger array unit. Consequently, as shown in FIG. 6, positions C2 to C4, i.e. the positions of the centroid of pixels-B, pixels-G, and pixels-W, overlap with position C1.

In this configuration, adder 145 computes color signals-R″, -G″, -B″, and -W″ by using following Eqs. (11) to (14).

R″=(Ra′+Rb′+Rc′+Rd′)/4 (11)

W″=(Wa′+Wb′+Wc′+Wd′)/4 (12)

B″=(Ba′+Bb′+Bc′+Bd′)/4 (13)

G″=(Ga′+Gb′+Gc′+Gd′)/4 (14)

Then, adder 145 forms luminance signal-Y″ in accordance with following Eq. (15), using respective added signals-R″, -G″, -B″, and -W″ obtained through the above computation.

Y″=k1×R″+k2×G″+k3×B″+k4×W″ (15)

On the other hand, the luminance signal of an NTSC system, for example, is expressed as following Eq. (16), in terms of spectral components R, G, and B.

Y=0.30×R+0.59×G+0.11×B (16)

In accordance with Eq. (15) and Eq. (16), coefficients k1 to k4 may be chosen so as to satisfy k1+k4=0.30, k2+k 4=0.59, and k3+k4=0.11. For example, a setting as k4=0.10 yields k1=0.20, k2=0.49, and K3=0.01.

Note that, when the Mg-filters are used instead of the W-filters, luminance signal-Ya is configured as follows.

Ya=1/2×Ra′+2×Ga′+1/2×Ba′+1/2×Mga′ (17)

Added signal-Ra′, added signal-Ga′, and added signal-Ba' are averages of signals-Ra, signals-Ga, and signals-Ba in Block-A, respectively, in the same manner as described above. In signal-Mga, its horizontal and vertical modulation components are in opposite phase with those of signals-Ra and signals-Ba. For this reason, the addition according to Eq. (17) allows a cancelation of the modulation components of signals-Ra and signals-Ba. In this way, the use of the Mg-filters brings about the same advantage as that of the W-filters.

(1-4. Operation of Video Camcorder)

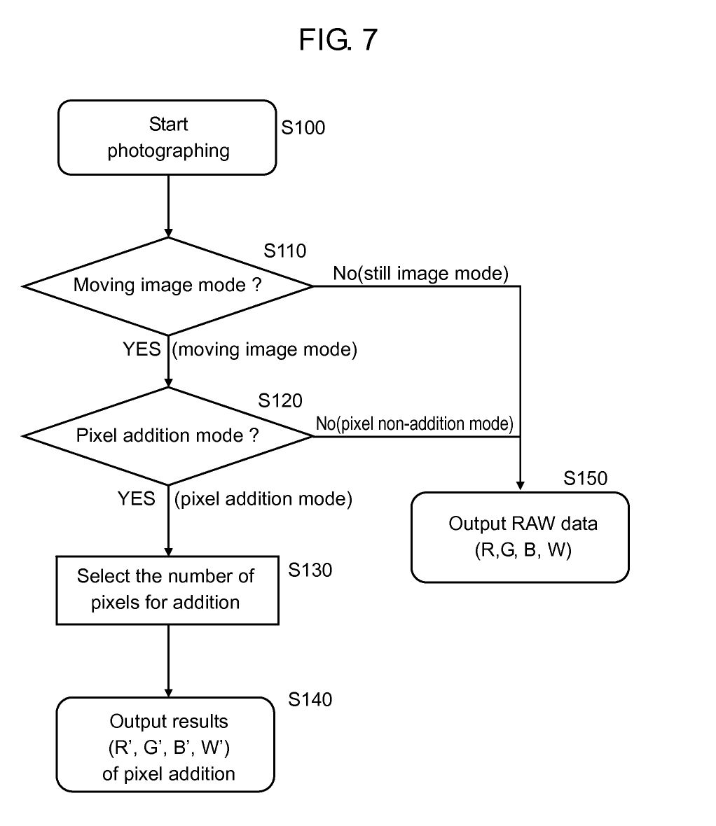

Hereinafter, operation of video camcorder 100 will be described. Also, operation of sensor 140 mounted in video camcorder 100 will be described with reference to FIG. 7.

Upon turning-on the power of video camcorder 100, controller 180 supplies electric power to every part which configures video camcorder 100. This operation allows initialization of each lens configuring optical system 110, sensor 140, and the like. After having finished the initialization of optical system 110, sensor 140, and the like, video camcorder 100 becomes ready for generating images.

Video camcorder 100 has two modes, i.e. a recording mode and a reproducing mode. A description of the operation of video camcorder 100 in the reproducing mode is omitted. When video camcorder 100, being set in the recording mode, becomes ready for generating images, display monitor 220 starts to display a through-image which is imaged with sensor 140 and processed with image processing unit 160.

During displaying the through-image on display monitor 220, controller 180 monitors whether or not the instruction button for generating still images is pressed and whether or not the instruction button for generating moving images is pressed. Following the pressing of either of the instruction buttons, controller 180 starts to generate images in the instructed mode (S100). That is, upon pressing of the instruction button for generating still images, controller 180 sets its operation mode to a still image mode. Moreover, upon pressing of the instruction button for generating moving images, controller 180 sets its operation mode to a moving image mode.

In accordance with the thus- set operation mode (the still image mode or the moving image mode), sensor 140 switches the output mode of the image data (S110). Specifically, when the still image mode is set (No, in Step S110), sensor 140 outputs RAW data configured with signals output from the respective pixels, without performing the pixel addition for the outputs from the pixels with adder 145 (S150). With this operation, when the still image mode is set, it is possible to output high-definition image data.

Video camcorder 100 has two output modes in the moving image mode, i.e. a pixel addition mode and a pixel non-addition mode. In the pixel addition mode, adder 145 performs the pixel addition for the output signals from the respective pixels. In the pixel non-addition mode, adder 145 does not perform the pixel addition. A user can select, in advance, any one of the pixel addition mode and the pixel non-addition mode. In the moving image mode, adder 145 of sensor 140 switches the output modes of the image data in accordance with the pre-selected output mode (the pixel addition mode or the pixel non-addition mode) (S120).

Specifically, when the operation mode is selected to be the moving image mode (Yes, in Step S110), adder 145 determines whether or not the output mode is set to pixel addition mode (S120). When the pixel non-addition mode is set (No, in S120), sensor 140 outputs the RAW data configured with the signals output from the respective pixels, without preforming the pixel addition for the output signals from the pixels (S150).

For example, in generating moving images, the output of the RAW data from all the pixels without performing the pixel addition is useful in cases where higher-definition image data are to be obtained even at lower frame rates, or where both moving images and still images are to be generated simultaneously.

On the other hand, when the pixel addition mode is set (Yes, in S120), sensor 140 selects a ratio at which the respective output signals from pixels-R, -G, -B, and -W are added in the pixel addition (S130). Note that, the configuration may be devoid of the step of selecting the ratio in the pixel addition. In this case, presetting of a predetermined addition rate is required.

Adder 145 performs the pixel addition processing for the output signals from respective pixels-R, -G, -B, and -W, in accordance with the selected addition ratio. Then, adder 145 outputs the signals obtained through the pixel addition (S140). Hereinafter, the output signals from pixels-R, -G, -B, and -W are referred to as “signal-R,” “signal-G,” “signal-B,” and “signal-W,” respectively.

As described above, applying the pixel addition to signals-R, -G, -B, and -W output from respective pixels-R, -G, -B, and -W is useful in cases, for example, where a smooth image is to be obtained by increasing the frame rate in generating moving images, or where an S/N ratio is to be improved even under low light conditions.

(1-5. Operation of Pixel Addition)

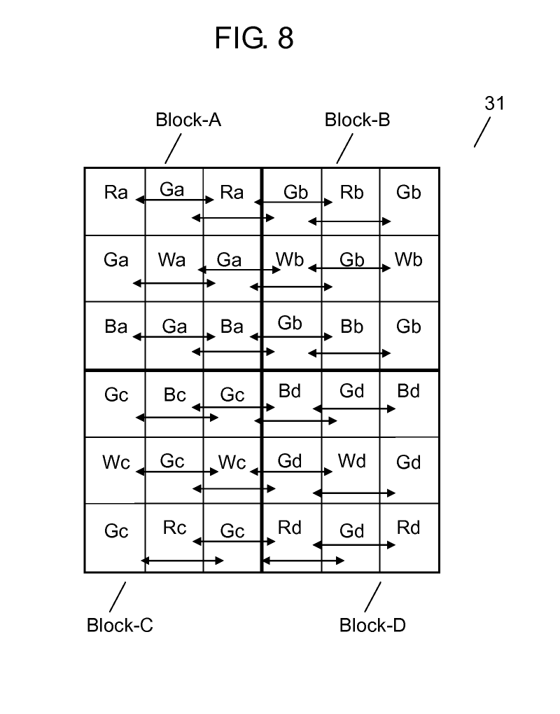

Hereinafter, another sequence of pixel addition operations by sensor 140 will be described in detail with reference to FIGS. 8 to 10. In the method according to Eqs. (1) to (15), the added signals are computed for every smaller array unit. On the other hand, in the following descriptions, the added signals are computed for every two adjacent ones of the smaller array units. Sensor 140 generates added signals by performing computations according to following Eqs. (18) to (22) for the output signals (R, G, B, and W) from the respective pixels (R, G, B, and W). As shown in FIG. 8, for example, sensor 140 performs an addition averaging between a plurality of signals-Ra output from pixels-Ra in Block-A and signal-Rb output from pixel-Rb in Block-B, thereby generating one signal (Ra+Rb)′. Similar computations are performed for the other color components. It is noted, however, that Eq. (20) and Eq. (21) are respectively used to determine the addition average (Ga+Gb)′ of G-signals of an even-numbered row and the addition average (Ga+Gb)″ of G-signals of odd-numbered rows.

(Ra+Rb)′=(Ra+Ra+Rb)/3 (18)

(Ba+Bb)′=(Ba+Ba+Bb)/3 (19)

(Ga+Gb)′=(Ga+Gb+Gb)/3 (20)

(Ga+Gb)″=(Ga+Ga+Gb)/3 (21)

(Wa+Wb)′=(Wa+Wb+Wb)/3 (22)

That is, adder 145 of sensor 140 determines the following values according to Block-A and Block-B which are two smaller array units among the plurality of types of the smaller array units located in the first row of larger array unit 31. That is, adder 145 determines addition average (Ra+Rb)′ of first output signals-R, addition average (Ba+Bb)′ of second output signals-B, addition average (Wa+Wb)′ of fourth output signals-W, addition average (Ga+Gb)′ of third output signals-G in the odd-numbered rows of Block-A and Block-B, and addition average (Ga+Gb)″ of third output signals-G in the even-numbered row of Block-A and Block-B. Likewise, adder 145 performs the similar computation for Block-C and Block-D which are two smaller array units among the plurality of types of the smaller array units located in the second row of larger array unit 31. Adder 145 determines addition average (Rc+Rd)' of first output signals-R, addition average (Bc+Bd)′ of second output signals-B, addition average (Wc+Wd)′ of fourth output signals-W, addition average (Gc+Gd)′ of third output signals-G in the odd-numbered rows of Block-C and Block-D, and addition average (Gc+Gd)″ of third output signals-G in the even-numbered row of Block-C and Block-D. Adder 145 outputs, to image processing unit 160 via ADC 150, the thus-obtained added signals including: (Ra+Rb)′, (Ga+Gb)′, (Ga+Gb)″, (Ba+Bb)′, (Wa+Wb)′, (Rc+Rd)′, (Gc+Gd)′, (Gc+Gd)″, (Bc+Bd)′, and (Wc+Wd)′.

(1-6. Operation of Image Processing Unit)

When the pixel addition mode is selected, sensor 140 outputs the added signals formed through the pixel addition, including: (Ra+Rb)′, (Ga+Gb)′, (Ga+Gb)″, (Ba+Bb)′, (Wa+Wb)′, (Rc+Rd)′, (Gc+Gd)′, (Gc+Gd)″, (Bc+Bd)′, and (Wc+Wd)′. These added signals are the addition averages of the output signals from the pixels respectively concerned.

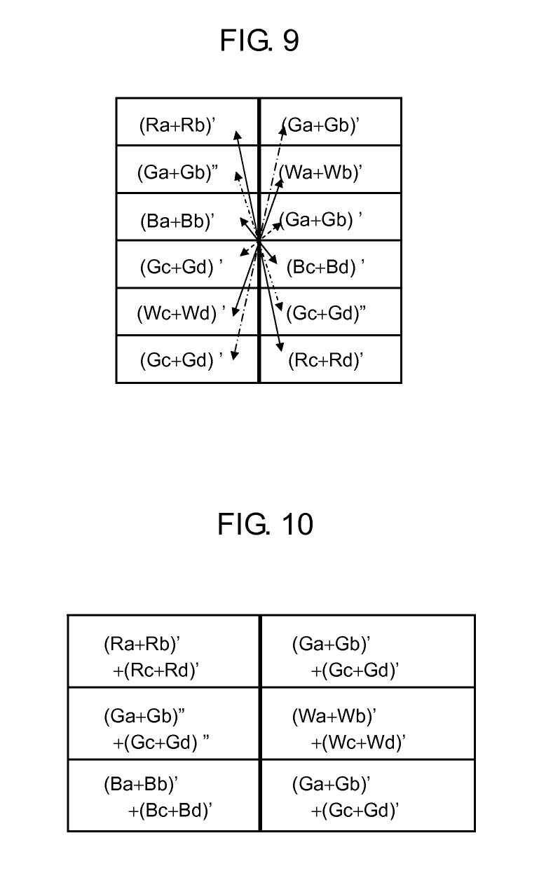

These added signals can be considered to be in a state, as shown in FIG. 9, where added color filters are arranged at mutually point-symmetrical locations about the center. Accordingly, as a result of the addition processing described above, the 36 pixel outputs shown in FIG. 8 are compressed to 12 pixel outputs. In these added signals, false signals are cancelled. For this reason, after the signal processing according to following Eq. (23) to Eq. (26), luminance signal-Y′ may be generated according to Eq. (27).

R′=((Ra+Rb)′/2+(Rc+Rd)′/2)/2 (23)

B′=((Ba+Bb)′/2+(Bc+Bd)′/2)/2 (24)

G′=((Ga+Gb)′+(Ga+Gb)″)/4+((Gc+Gd)′+(Gc+Gd)″)/4 (25)

W′=((Wa+Wb)′/2+(Wc+Wd)′/2)/2 (26)

Y′=0.213×R′+0.715×G′+0.072×B′+k×W′ (27)

Note that the respective coefficients of R′, G′, and B′ in Eq. (27) are the coefficients defined in the standard specification of BTA S-001C. Moreover, the coefficient k of W′ may be determined in consideration of an illuminance of the subject whose image is generated, for example. That is, image processing unit 160 may select the coefficient for addition average W′ of the fourth outputs in accordance with the illuminance of the subject.

In the course of this addition processing, the 36 pixel outputs shown in FIG. 8 may be compressed down to the six pixel outputs as shown in FIG. 10. In this way, by applying such further addition processing to the pixel outputs arranged point-symmetrically shown in FIG. 9 to compress them down to the six pixel outputs, it is possible to increase the frame rate and to suppress the false signals.

Although the pixel addition described with reference to FIGS. 9 and 10 may be performed in image processing unit 160, it is preferably performed in sensor 140. Performing the pixel addition in sensor 140, i.e. adder 145, allows an increased efficiency of the image output over the entire image area within a limited period of time.

Performing of the pixel addition increases the frame rate of the output, on the other hand, decreases resolution. For this reason, in the case where a higher priority is placed on resolution, the processes up to FIG. 9 are preferably performed in adder 145, followed by performing the subsequent processes in image processing unit 160. On the other hand, in the case where a higher priority is placed on an increased frame rate, the processes up to FIG. 10 are preferably performed in adder 145, followed by performing the subsequent processes in image processing unit 160.

In either case, image processing unit 160 determines addition average-R′ of first output signals-R, addition average-B′ of second output signals-B, and addition average-W′ of fourth output signals-W, in larger array unit 31. Moreover, image processing unit 160 determines addition average-G′ between addition average (Ga+Gb)′ of third output signals-G in the odd-numbered rows of the plurality of types of the smaller array units included in larger array unit 31 and addition average (Ga+Gb)″ of third output signals-G in the even-numbered rows of the plurality of types of the smaller array units included in the larger array unit.

Then, addition average-R′, addition average-B′, addition average-W′, addition average-G′ are multiplied by the respective coefficients, and the resulting values are summed to yield luminance signal-Y′.

### OTHER EXEMPLARY EMBODIMENTS

As described above, the embodiment has been described using the example of larger array unit 31. However, the idea of the embodiment described above is not limited to the example. Hereinafter, other embodiments to which the idea of the embodiment described above is applicable will be collectively described.

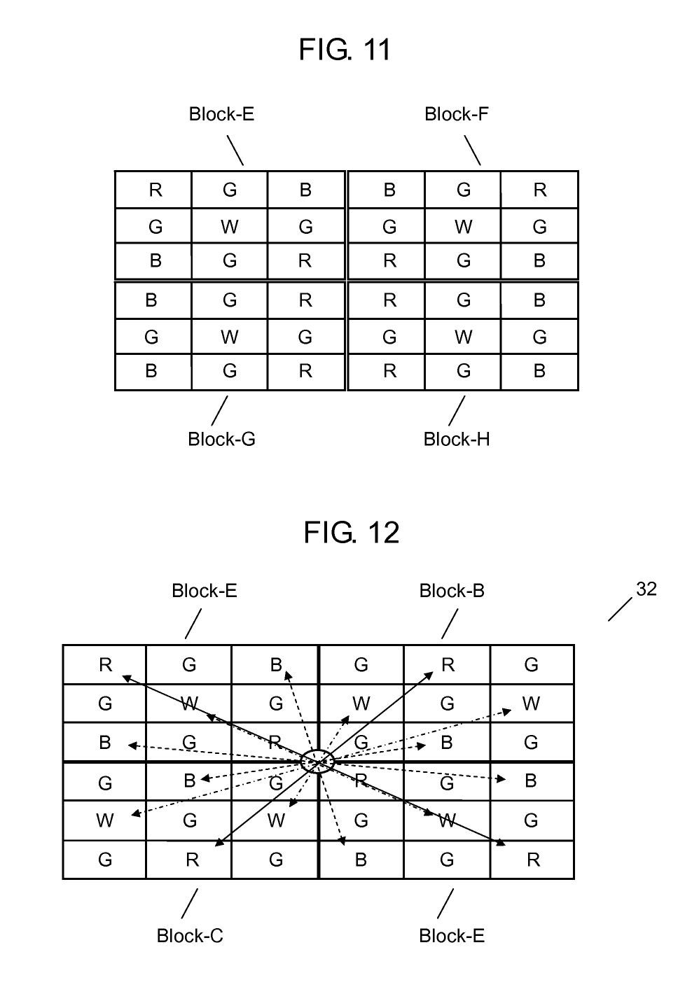

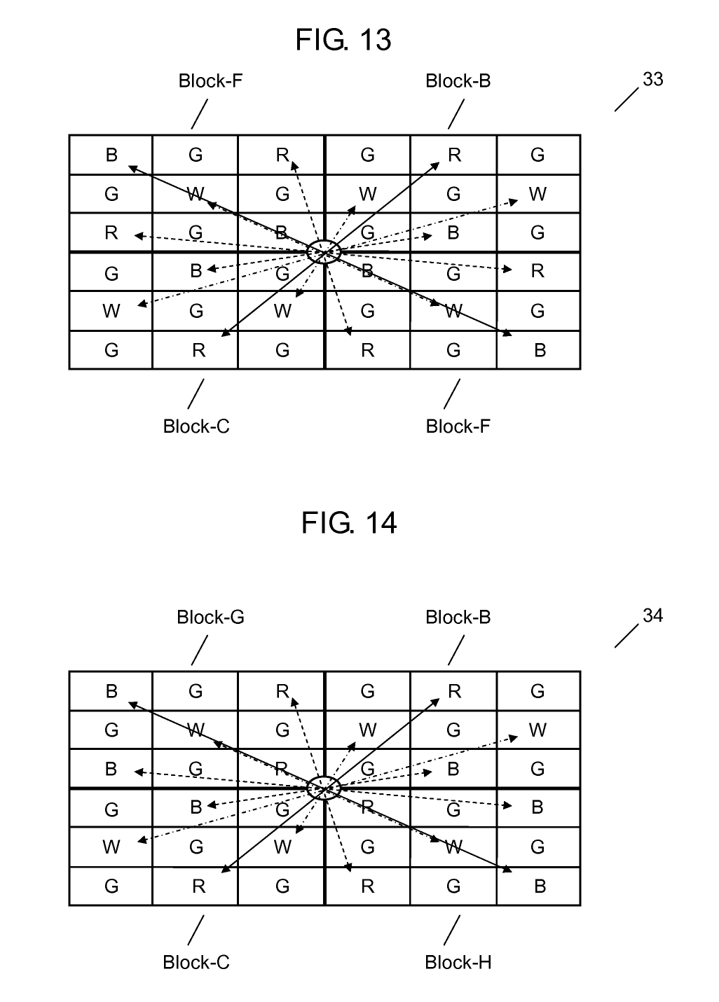

Although, in the aforementioned descriptions, the configuration has been described using the case where larger array unit 31 is configured with the smaller array units from Block-A to Block-D shown in FIG. 4, the configuration is not limited to this. As other examples of smaller array units, FIG. 11 shows the units from Block-E to Block-H. Moreover, larger array units 32, 33, and 34 which each include some of these smaller array units are shown in FIGS. 12 to 14, respectively. As shown in in FIGS. 12 to 14, even in these cases, the centroid positions of R, B, W, and G resulted from the respective pixel additions coincide with each other. In addition, their false signals are removed because of the point symmetry of the respective colors.

In the embodiments described above, CMOS image sensor 140 is exemplified as the imaging element; however, the imaging element is not limited to it. For example, the imaging element may be configured with a CCD image sensor, an NMOS image sensor, or the like.

In the embodiments described above, the pixel addition is applied only when generating moving images. In addition, the pixel addition may also be applied when generating still images. Alternatively, the pixel addition may also be applied in a DSC exclusively for generating still images. For example, the pixel addition may be applied in a continuous shooting mode.

Moreover, image processing unit 160 and controller 180 may be configured with one semiconductor chip, or alternatively configured with separate semiconductor chips.

In the embodiments, sensor 140 incorporates adder 145 that performs the pixel addition and outputs the added pixel signals; however, the idea of the embodiments is not limited to this. That is, the pixel addition may be performed with a computation processing unit (e.g. image processing unit 160) which is disposed in the subsequent stage to sensor 140. Even with this configuration, the signals (image information) can be output more efficiently.

As described above, in accordance with the embodiments, it is possible to generate the luminance signals and color signals, free of false signals, by performing the pixel addition according to the array of signals generated by sensor 140. With this configuration, even in the case where a high-definition image sensor suitable for still images is used for generating moving images, it is possible to perform the pixel signal processing with a high efficiency, resulting in setting of the appropriate frame rate with ease in generating moving images as well.

The idea of the embodiments is applicable to DSCs, information terminals equipped with imaging elements, etc., as well as video camcorders.

What is claimed is:

1. An imaging element comprising:
a plurality of types of smaller array units each including a plurality of color filters disposed in three rows by three columns, the color filters including a first color filter and a second color filter having a spectral characteristic different from that of the first color filter; and
a larger array unit including the plurality of the types of the smaller array units disposed in two rows by two columns,
wherein the plurality of the types of the smaller array units are disposed such that, in the larger array unit, a first centroid position of pixels used in pixel addition processing for pixel information based on light transmitted through the first color filters coincides with a second centroid position of pixels used in pixel addition processing for pixel information based on light transmitted through the second color filters.

2. The imaging element according to claim 1, wherein, in each of the plurality of the types of the smaller array units, the first color filter and the second color filter are disposed point-symmetrically to each other.

3. The imaging element according to claim 1,
wherein each of the plurality of the types of the smaller array units includes a plurality of third color filters disposed checkerwise and having a spectral characteristic different from those of the first color filter and the second color filter; and
the plurality of the types of the smaller array units are disposed such that, in the larger array unit, a third centroid position of pixels used in pixel addition processing for pixel information based on light transmitted through the plurality of the third color filters coincides with the first centroid position and the second centroid position.

4. The imaging element according to claim 3, wherein the first color filter is an R-filter, the second color filter is a B-filter, and each of the plurality of the third color filters is a G-filter.

5. The imaging element according to claim 3,
wherein each of the plurality of the types of the smaller array units further includes a fourth color filter having a spectral characteristic different from those of the first color filter, the second color filter, and the third color filters, and the fourth color filter has an optical transmittance higher than that of any of the first color filter and the second color filter, and
wherein the plurality of the types of the smaller array units are disposed such that, in the larger array unit, a fourth centroid position of pixels used in pixel addition processing for pixel information based on light transmitted through the fourth color filters coincides with the first centroid position, the second centroid position, and the third centroid position.

6. The imaging element according to claim 5, wherein the fourth color filter is capable of transmitting light having wavelengths including a wavelength of light transmitted through any of the first color filter, the second color filter, and the plurality of the third color filters.

7. The imaging element according to claim 5, wherein the fourth color filter is a W-filter having an optical transmittance higher than that of the third color filters.

8. The imaging element according to claim 5, wherein the fourth color filter is a Mg-filter.

9. An imaging apparatus comprising:
an imaging element; and
an image processing unit configured to process image information generated by the imaging element,
wherein the imaging element includes:
a plurality of types of smaller array units each including:
a plurality of color filters disposed in three rows by three columns, the color filters including a first color filter and a second color filter having a spectral characteristic different from that of the first color filter; and
a larger array unit including the plurality of the types of the smaller array units disposed in two rows by two columns, and
wherein the plurality of the types of the smaller array units are disposed such that, in the larger array unit, a first centroid position of pixels used in pixel addition processing for pixel information based on light transmitted through the first color filters coincides with a second centroid position of pixels used in pixel addition processing for pixel information based on light transmitted through the second color filters.

10. The imaging apparatus according to claim 9,
wherein, in the each of the plurality of the types of the smaller array units, the first color filter and the second color filter are disposed point-symmetrically to each other.

11. The imaging apparatus according to claim 9,
wherein, in the imaging element, each of the plurality of the types of the smaller array units includes a plurality of third color filters disposed checkerwise and having a spectral characteristic different from those of the first color filter and the second color filter; and
the plurality of the types of the smaller array units are disposed such that, in the larger array unit, a third centroid position of pixels used in pixel addition processing for pixel information based on light transmitted through the plurality of the third color filters coincides with the first centroid position and the second centroid position.

12. The imaging apparatus according to claim 11,
wherein, in the imaging element, each of the plurality of the types of the smaller array units further includes a fourth color filter having a spectral characteristic different from those of the first color filter, the second color filter, and the third color filters, the fourth color filter having an optical transmittance higher than that of any of the first color filter and the second color filter, and
wherein the plurality of the types of the smaller array units are disposed such that, in the larger array unit, a fourth centroid position of pixels used in pixel addition processing for pixel information based on light transmitted through the fourth color filters coincides with the first centroid position, the second centroid position, and the third centroid position.

13. The imaging apparatus according to claim 12,
wherein the imaging element further includes a plurality of pixels disposed at locations where the pixels receive light transmitted through the respective first to fourth color filters, and each of the plurality of the pixels located at locations corresponding to the respective first to fourth filters outputs first to fourth output signals, respectively,
wherein the image processing unit determines
an addition average of the first output signals in the larger array unit,
an addition average of the second output signals in the larger array unit,
an addition average of the fourth output signals in the larger array unit, and
an addition average between an addition average of the third output signals in odd-numbered rows of the plurality of the types of the smaller array units included in the larger array unit and an addition average of the third output signals in even-numbered rows of the plurality of the types of the smaller array units included in the larger array unit, and
wherein the image processing unit generates a luminance signal by multiplying, by respective coefficients,
the addition average of the first output signals,
the addition average of the second output signals,
the addition average of the fourth output signals, and
the addition average between the addition average of the third output signals in the odd-numbered rows and the addition average of the third output signals in the even-numbered rows, and by adding the resulting addition averages of the multiplications.

14. The imaging apparatus according to claim 13,
wherein, in two units, among the plurality of the types of the smaller array units, located in a first row of the larger array unit, the imaging element determines
an addition average of the first output signals,
an addition average of the second output signals,
an addition average of the fourth output signals,
an addition average of the third output signals in odd-numbered rows of the two units located in the first row, and
an addition average of the third output signals in even-numbered rows of the two units located in the first row,
wherein, in two units among the plurality of the types of the smaller array units, located in a second row of the larger array unit, the imaging element determines
an addition average of the first output signals,
an addition average of the second output signals,
an addition average of the fourth output signals,
an addition average of the third output signals in odd-numbered rows of the two units located in the second row, and
an addition average of the third output signals in even-numbered rows of the two units located in the second row, and
wherein the imaging element outputs the resulting addition averages of the determinations to the image processing unit.

15. The imaging apparatus according to claim 13, wherein the image processing unit selects the coefficient to be multiplied with the addition average of the fourth output signals in accordance with an illuminance of a subject.

16. The imaging apparatus according to claim 12, wherein the fourth color filter is a W-filter having an optical transmittance higher than that of the third color filters.

17. The imaging apparatus according to claim 12, wherein the fourth color filter is a Mg-filter.
